(19) United States
(12) Patent Application Publication
(10) Pub. No.: US 2023/0075432 A1
(43) Pub. Date: Mar. 9, 2023

(54) APPARATUS, SYSTEM AND METHOD FOR PROVIDING A MANUFACTURING GRIPPING NOZZLE

(71) Applicant: JABIL INC., St. Petersburg, FL (US)

(72) Inventor: JEROEN BOSBOOM, St. Petersburg, FL (US)

(73) Assignee: JABIL INC., St. Petersburg, FL (US)

(21) Appl. No.: 17/800,440

(22) PCT Filed: Feb. 17, 2020
(86) PCT No.: PCT/US2020/018514

§ 371 Date: Aug. 17, 2022

(51) Int. Cl. B25J 15/06; B65G 49/06

(52) U.S. Cl. CPC B25J 15/0616; B65G 49/061

(57) ABSTRACT

An apparatus, system and method for providing a manufacturing gripping nozzle. The apparatus, system and method for gripping an in-process component during processing may include: a chuck; at least two walls extending from the chuck; at least two peripheral guides having a size and shape correspondent to a periphery of the component and placed atop the at least two walls distal from the chuck, wherein the at least two peripheral guides are capable of positionally maintaining the periphery during the processing; and at least one Bernoulli cup within a cavity bounded by the chuck, the at least two walls, and the component, wherein the at least one Bernoulli cup non-contactedly grips the component.

### CROSS-REFERENCE TO RELATED APPLICATION

This application claims the benefit of priority to International Application No. PCT/US2020/018514, filed Feb. 17, 2020; entitled APPARATUS, SYSTEM AND METHOD FOR PROVIDING A MANUFACTURING GRIPPING NOZZLE, the entirety of which is incorporated herein by reference as if set forth in its entirety.

### BACKGROUND

### Field of the Disclosure

The present disclosure relates to the transfer and processing of articles and components, and more particularly to an apparatus, system and method for providing a manufacturing gripping nozzle.

### Description of the Background

The use of robotics is well established as a manufacturing expedient, particularly in applications where human handling is inefficient and/or undesirable. For example, robotics and automated stations are often used to handle and hold component parts during various manufacturing process steps. Correspondingly, such components may require holding in a vacuum chuck.

During manufacturing processes, it is typical that combination electronic and mechanical (“electromechanical”) parts and products must be handled for process operations and movement between process steps. However, the small and delicate nature of certain components of these parts and products, as well as the highly sensitive nature of aspects of the parts and products, such as electronic components, lenses, display surfaces, and the like, often requires protection of these aspects and small components during processing and between processes. Such protections typically comprise removable protective films.

Simply put, these protective films are generally attached to delicate aspects, such as lenses or displays, of parts and products during manufacture, to provide protection to those aspects during certain process steps, and then must be removed for subsequent process steps. However, during some manufacturing processes, these protective films may added, then removed, then re-added, then removed anew, and so on, creating substantial inefficiencies and additional process steps in the manufacturing process.

Worse yet, each time such a protective film is added and removed, static electricity, undesirable stickiness on the part, and sticky trash (once the film is removed) is generated. More particularly, due to the inherent static build up, these protective liners tend to cling to random surfaces and defy desired control. Moreover, as the protective films often include adhesives to temporarily adhere to the part to be protected, the films may stick to a line operator’s hands, or to the automated tooling. Further, if the films are spooled, such as using sticky tape, for dispersal, these spools need to be maintained and replenished, and the sticky aspects thereof must be kept away from other process materials and tooling.

These protective liners may also be placed over sensitive surfaces in order to avoid contamination. Although these liners can be placed and removed by hand or with automation, as discussed throughout, to best prevent contamination an automated placement and removal may be preferable. However, a need to automate these processes necessitates a substantial investment in process machinery over and above the equipment necessary solely to the core process.

By way of non-limiting example, during the manufacturing process thereof, virtual reality glasses may have placed upon its lenses a protective film so as to avoid smudging and other damage. Although these protective films may be critical to improve product yield, placement, removal, replacement, and re-removal build significant inefficiencies into the manufacturing process.

### SUMMARY

Certain embodiments are and include an apparatus, system and method for providing a manufacturing gripping nozzle. The retention nozzle for gripping an in-process component during processing may include: a chuck; at least two walls extending from the chuck; at least two peripheral guides having a size and shape correspondent to a periphery of the component and placed atop the at least two walls distal from the chuck, wherein the at least two peripheral guides are capable of positionally maintaining the periphery during the processing; and at least one Bernoulli cup within a cavity bounded by the chuck, the at least two walls, and the component, wherein the at least one Bernoulli cup non-contactedly grips the component.

The retention nozzle may further include a vacuum inlet to the chuck. The at least two peripheral guides may be removable. The component may comprise a lens or a display.

Actuation tooling may be physically associated with the chuck. The actuation tooling may be capable of rotating the chuck. The actuation tooling may be capable of retracting the at least one Bernoulli cup. The actuation tooling may comprise robotics.

A method and system for gripping an in-process component during processing may include: a chuck associated with tooling suitable to provide planar and rotational motion to the chuck, wherein the tooling actuates the motion and the chuck responsive to non-transitory computing instructions from at least one computing processor; at least two walls extending from the chuck distally from the tooling; at least two peripheral guides having a size and shape correspondent to a periphery of the component and placed atop the at least two walls distal from a base of the chuck, wherein the at least two peripheral guides are capable of positionally maintaining the periphery during the processing; and at least two Bernoulli cups within a cavity bounded by the chuck, the at least two walls, and the component, wherein the at least two Bernoulli cups grip the component without contact.

### BRIEF DESCRIPTION OF THE DRAWINGS

The exemplary compositions, systems, and methods shall be described hereinafter with reference to the attached drawings, which are given as non-limiting examples only, in which:

FIG. 1 is an illustration of a manufacturing nozzle;

FIG. 2 is an illustration of a manufacturing nozzle; and

FIG. 3 is an illustration of a manufacturing nozzle.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the disclosed embodiments should not be construed to limit the scope of the disclosure. As referenced above, in some embodiments, well-known processes, well-known device structures, and well-known technologies may not be described in detail.

The terminology used herein is for the purpose of describing particular embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on”, “upon”, “connected to” or “coupled to” another element or layer, it may be directly on, upon, connected or coupled to the other element or layer, or intervening elements or layers may be present, unless clearly indicated otherwise. In contrast, when an element or layer is referred to as being “directly on,” “directly upon”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Thus, terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the embodiments.

The embodiments are and include a form fitting metal or plastic nozzle, which may be sized and/or have replaceable part-adjacent contoured guides so as to conform to the part to be handled. The nozzle may include one or more Bernoulli cups within the nozzle body. The form-fitting (to the part) part-adjacent peripheral guides may keep the part from shifting laterally in the x or y axis while the part is held by the nozzle.

In a typical manufacturing process, process components are typically organized in open trays. They are picked from the trays, and are placed into in-manufacture assemblies. In the current state of the art, a protective film may typically be applied to certain highly sensitive components, so that the components can be contacted by the picker without damage or smudging. Thereafter, the protective film must be peeled off of that component to allow for a subsequent process step.

The embodiments eliminate the need for protective films on manufacturing components by providing miniature picking and handling nozzles. These nozzles may include form fitted guides immediately adjacent to the gripped component, and may additionally include Bernoulli cups to provide a non-contact grip on a surface of the gripped component. That is, since Bernoulli cups create a boundary air layer between the cup surface and the “gripped” surface of an object brought into close proximity, there may be a 30-40 micron gap and no contact between the cup mouth and the gripped surface.

Various aspects of the disclosed picker/handler may, by way of non-limiting example, be 3D printed. For example, the form fitting peripheral guides may vary in size and shape in accordance with the gripped component, and may be 3D printed. Likewise, the Bernoulli nozzles may be 3D printed, as may be the frame into which the Bernoulli cups and/or the peripheral guides are removably inserted.

The disclosed gripping nozzle allows the picking and handling of parts of various shapes and sizes to be automated, such as for machine-picking by manufacturing robotics. The disclosed gripping nozzle saves labor and the manufacturing cost of placing and removing protective peels, which may be sticky, staticky, and which may be difficult to dispose of.

The axial positioning of the component during gripping depends on the boundary features of the object as framed within the peripheral guides. This axial positioning is maintained while a large non-contact gripping face maintains a grip on the object as the object is framed by its periphery in the x, y and z axes according to the peripheral guide. For example, a lens face of a given shape may be positionally maintained within a guide countoured to its shape, and may be non-contactedly gripped by the Bernoulli cups. By using Bernoulli cups, contact is avoided and the chance of contaminating crucial surfaces is thus reduced.

The z axis of the disclosed nozzle may be supported by the nozzle actuation tooling, and should be sufficient to support the insertion loads provided by the gripped part and the movement of the gripped part that must be made in a given process. This tooling may also control planarity, and may allow for seating and pressing of gripped components into contact with mating faces.

The lateral and axial guide faces can be actuated independently by servo or pneumatic controls included in the tooling, by way of non-limiting example. Further, the lateral and axial control enables control of the x-y component offset with respect to the vertical chuck axis. The axial offset may also be used to set the boundary gap and to seat the component into a socket, mating face, solder paste, glue, PSA, and so on.

In certain ones of the additional embodiments, the Bernoulli cup(s) may be retractable, either before or while the lateral guides clamp the part. The gripped component may then be aligned, such as with the aid of automated inspection equipment, for live placement to an optimum position, in part because the retracted Bernoulli cup is no longer blocking the optics used for a vision-based placement.

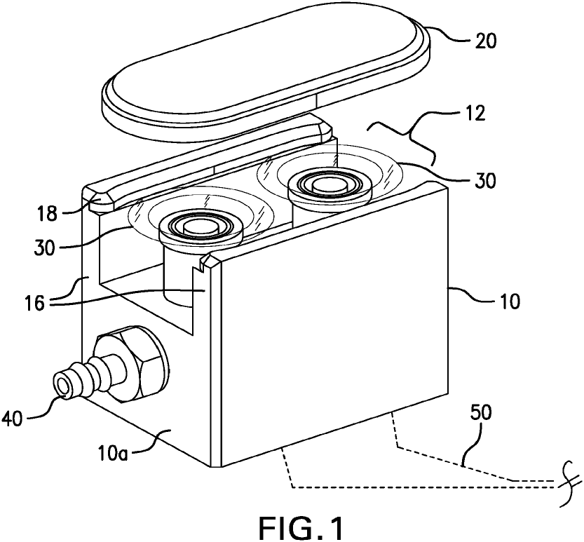

FIG. 1 illustrates a chuck 10 having a nozzle portion 12 according to the embodiments. The illustrated nozzle 12 includes substantially parallel chuck walls 16, having atop thereof a plurality of replaceable peripheral guides 18 which may be sized and shaped so as to receive component 20.

Within the chuck 10, such as at the base of the chuck walls 16, is at least one Bernoulli cup 30. The at least one Bernoulli cup 30 is suitable to non-contactedly grip the component 20 when the component 20 is seated within the peripheral guides 18. The Bernoulli cups 30 may be removable and replaceable, and may, in some embodiments, be retractable, either synchronously or asynchronously.

Also included in the chuck base 10a may be one or more vacuum ports 40 to provide a vacuum at Bernoulli cup 30. Yet further, the chuck 10 may be in communication with actuation tooling 50 which may move the chuck 10 in three dimensions, and which may include aspects capable of actuating features associated with the chuck 10, such as retraction of the Bernoulli cups 30, by way of non-limiting example.

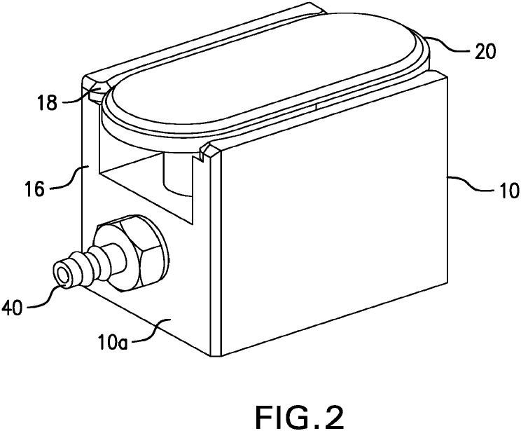

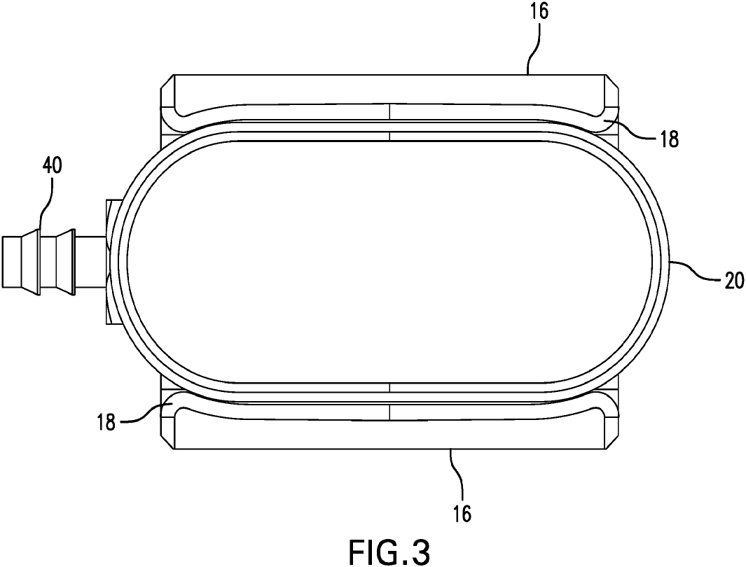

FIGS. 2 and 3 illustrate component 20 gripped within nozzle 12. FIG. 2 is a profile view of the gripping and handling. FIG. 3 provides a top view of the same. Of note, and as is particularly illustrated in FIG. 3, the peripheral guides 18 may be sized and shaped so as to provide gripping of the peripheral contours of component 20. As referenced above, these peripheral guides 18 may be removable and replaceable from chuck 10, or the entire chuck 10 may be switched out dependent on the component 20 size and shape to be gripped in a given manufacturing process.

The foregoing apparatuses, systems and methods may also include the control of the various robotic and vacuum functionality referenced throughout. Such control may include, by way of non-limiting example, manual control using one or more user interfaces, such as a controller, a keyboard, a mouse, a touch screen, or the like, to allow a user to input instructions for execution by software code associated with the robotics and with the systems discussed herein. Additionally, and as is well known to those skilled in the art, system control may also be fully automated, such as wherein manual user interaction only occurs to “set up” and program the referenced functionality, i.e., a user may only initially program or upload computing code to carry out the predetermined movements, vacuum draw and operational sequences discussed throughout. In either a manual or automated embodiment, or in any combination thereof, the control may be programmed, for example, to relate the known positions of substrates, the robotics, the stationary point, and the relative positions there between, for example.

It will further be appreciated that the herein described systems and methods may operate pursuant to and/or be controlled by any computing environment, and thus the computing environment employed is not to be presumed to limit the implementation of the herein described systems and methods in computing environments having various differing components and configurations. That is, the concepts described herein may be implemented in any of various computing environments using any of various components and configurations.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

What is claimed is:

1. A retention nozzle for gripping an in-process component during processing, comprising:
a chuck;
at least two walls extending from the chuck;
at least two peripheral guides having a size and shape correspondent to a periphery of the component and placed atop the at least two walls distal from the chuck, wherein the at least two peripheral guides are capable of positionally maintaining the periphery during the processing; and
at least one Bernoulli cup within a cavity bounded by the chuck, the at least two walls, and the component, wherein the at least one Bernoulli cup non-contactedly grips the component.

2. The retention nozzle of claim 1, further comprising a vacuum inlet to the chuck.

3. The retention nozzle of claim 1, wherein the at least two peripheral guides are removable.

4. The retention nozzle of claim 1, wherein the component comprises a lens.

5. The retention nozzle of claim 1, wherein the component comprises a display.

6. The retention nozzle of claim 1, wherein the processing comprises manufacturing.

7. The retention nozzle of claim 1, wherein the at least one Bernoulli cup comprises at least two Bernoulli cups.

8. The retention nozzle of claim 1, further comprising actuation tooling physically associated with the chuck.

9. The retention nozzle of claim 8, wherein the actuation tooling is capable of rotating the chuck.

10. The retention nozzle of claim 8, wherein the at least one Bernoulli cup is retractable.

11. The retention nozzle of claim 10, wherein the actuation tooling is capable of the retracting.

12. The retention nozzle of claim 8, wherein the actuation tooling comprises robotics.

13. A system for gripping an in-process component during processing, comprising:
a chuck associated with tooling suitable to provide planar and rotational motion to the chuck, wherein the tooling actuates the motion and the chuck responsive to non-transitory computing instructions from at least one computing processor;
at least two walls extending from the chuck distally from the tooling;
at least two peripheral guides having a size and shape correspondent to a periphery of the component and placed atop the at least two walls distal from a base of the chuck, wherein the at least two peripheral guides are capable of positionally maintaining the periphery during the processing; and
at least two Bernoulli cups within a cavity bounded by the chuck, the at least two walls, and the component, wherein the at least two Bernoulli cups grip the component without contact.

14. The system of claim 13, further comprising a vacuum inlet to the chuck.

15. The system of claim 13, wherein the at least two peripheral guides are removable.

16. The system of claim 13, wherein the component comprises a lens.

17. The system of claim 13, wherein the component comprises a display.

18. The system of claim 13, wherein the processing comprises manufacturing.

19. The system of claim 13, wherein the at least two Bernoulli cups are retractable.

20. The system of claim 19, wherein the actuation tooling is capable of the retracting.

21. The system of claim 13, wherein the actuation tooling comprises robotics.
